(19) United States
(12) Patent Application Publication
(10) Pub. No.: US 2005/0137879 A1
(43) Pub. Date: Jun. 23, 2005

(54) Electronic translator with a printing functionality

(75) Inventors: Ming-Wei Juang, Taipei County (TW); Chih-Cheng Chien, Taipei County (TW)

Correspondence Address: BACON & THOMAS, PLLC, 625 SLATERS LANE, FOURTH FLOOR, ALEXANDRIA, VA, 22314, US

(73) Assignee: Kinpo Electronics, Inc., Taipei (TW)

(21) Appl. No.: 10/847,351

(22) Filed: May 18, 2004

(30) Foreign Application Priority Data
Dec. 19, 2003 (TW) 092136268

(51) Int. Cl. G06F 17/28

(52) U.S. Cl. 704/276

(57) ABSTRACT

For an electronic translator with a printing functionality and related operation method, the electronic translator has a printer driver circuit and a small printer. When a user inquires about a vocabulary word, the electronic translator marks the vocabulary word and its corresponding data, and then prints out the data according to printing items set by the user.

### BACKGROUND OF THE INVENTION

1. Field of the Invention

The present invention relates to an electronic translator, and more particularly, to an electronic translator with a printing functionality.

2. Description of the Related Art

The electronic translator has recently become a very popular electronic product. A user uses the electronic translator to translate a vocabulary word not understood, and the user is able to obtain the pronunciation, meaning, tenses, related phrases, antonyms, and example sentences for the vocabulary word.

As shown in FIG. 1, a prior art electronic translator comprises a CPU 10, a display device 12, a memory 14, an input device 16, and an audio device 18. The display device 12 is an LCD (liquid crystal display) or an OLED (organic light-emitting diode), for displaying translation data. The memory 14 is a ROM (read-only memory) or a flash memory, for permanent storage of a plurality of vocabulary words and their corresponding translation data, and for storing newly added vocabulary words or an inquiry data recorded. The input device 16 is a keyboard or a touch panel, and is used for inputting a user inquiry data such as a vocabulary word. The audio device 18 is a speaker or a headphone, and provides speech audio or sound effects. The CPU 10 receives the inquiry data output from the input device 16, and compares the inquiry data to the vocabulary words stored in the memory 14. If the inquiry data matches one of the vocabulary words stored in the memory 14, the CPU 10 reads the corresponding translation data of the vocabulary word from the memory 14 and outputs the vocabulary word and the corresponding translation data to the display device 12 and the audio device 18, and so helps the user to understand the vocabulary word and its pronunciation.

However, when the user obtains the translation data and is not familiar with this vocabulary word, he or she might want to record this vocabulary word for memorization. A user having obtained the translation data and not being familiar with a particular term might want to record this term for memorization. However, it is only possible to write down the term and the related data which is very inconvenient for a user, especially one who likes to record a lot of vocabulary terms at one time. Therefore, it is desirable to provide an improved electronic translator to mitigate and/or obviate the aforementioned problems.

### SUMMARY OF THE INVENTION

A main objective of the present invention is to provide an electronic translator with printing functionality, which can print out inquiry data.

Another objective of the present invention is to provide an electronic translator with a printing functionality, which can provide different print column items so that a user can select different items to print.

To achieve the object, an electronic translator with a printing functionality of the present invention is provided, which includes a memory for storing a plurality of vocabulary words and corresponding translation data; an input device for inputting a command or data from a user; a central processing unit (CPU) for searching data from the memory according to the command or data; a display device for displaying searched data; a printer driving circuit for inputting the searched data from the CPU and outputting corresponding printing data; and a printer for printing the printing data.

To achieve the object, a method of providing printing functionality in an electronic translator is provided, which comprising: (A) selecting a information item of a corresponding translation data of a vocabulary word; (B) searching a vocabulary word according to the inquiry data; (C) determining whether the inquiry data will be printed; if so, performing step (D); if not, performing step (B); (D) marking the inquiry data; (E) determining whether another inquiry data is to be performed; if so, performing step (F); if not, performing step (B); (F) determining whether the inquiry data is to be printed out; if so, performing step (G); if not, performing step (B); and (G) printing out the selected information item of the marked inquiry data.

Other objects, advantages, and novel features of the invention will become more apparent from the following detailed description when taken in conjunction with the accompanying drawings.

### BRIEF DESCRIPTION OF THE DRAWINGS

FIG. 1 shows an electronic translator according to the prior art;

FIG. 2 is a hardware block diagram of an electronic translator with a printing functionality in accordance with the present invention; and

FIG. 3 is a flow chart of printing procedures for the electronic translator in accordance with the present invention.

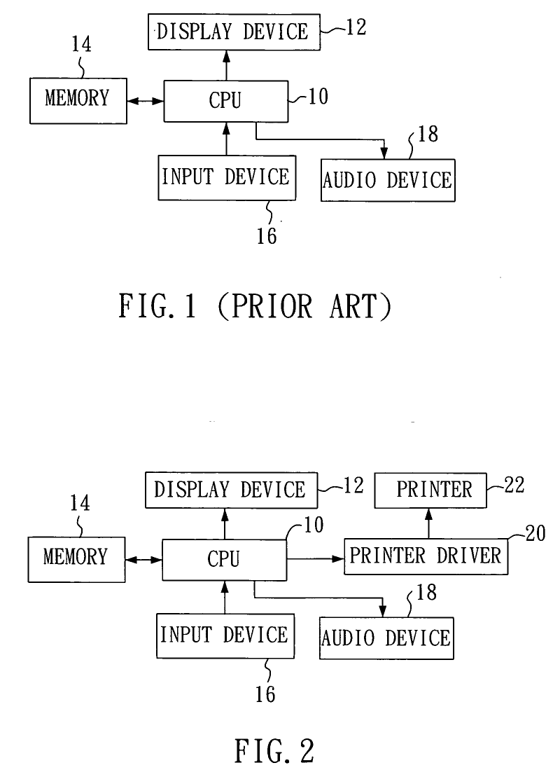

### DETAILED DESCRIPTION OF THE PREFERRED EMBODIMENT

FIG. 2 shows a hardware block diagram of an electronic translator with a printing functionality in accordance with the present invention. A preferred embodiment of the present invention comprises a CPU 10, a display device 12, a memory 14, an input device 16, an audio device 18, a printer driver 20 and a printer 22, wherein the CPU 10, the display device 12, the memory 14, the input device 16 and the audio device 18 are similar to the corresponding prior art items, and thus all of the items are not described in details. When the user operates the input device 16 to input an inquiry data, the CPU 10 receives this inquiry data, and then searches for a matching vocabulary word stored in the memory 14 and outputs the inquiry data and the translation data corresponding to the matching vocabulary word to the display device 12 and the printer driver 20. Then, the display device 12 displays the vocabulary word and the corresponding translation data. The user can also use the input device 16 to input an inquiry data to select an information item of the inquiry data. The CPU 10 records this inquiry data and outputs both the information item selected and the inquiry data. The printer driver 20 receives the information item selected and the inquiry data and drives the printer 22 to print the data out.

Therefore, the inquiry data can be printed onto paper so that the user does not need to write down the data by hand. If the user uses adhesive printing paper, this printing paper having vocabulary data can be stuck to a collecting card or a book.

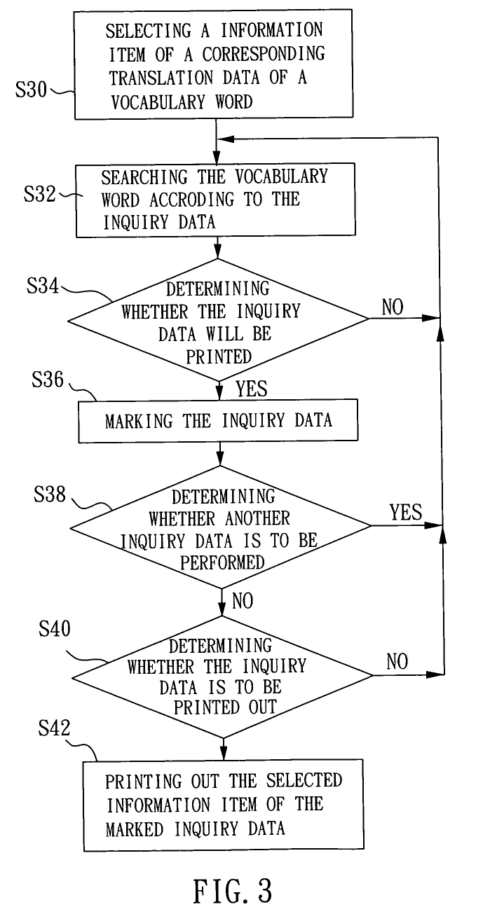

FIG. 3 shows a flow chart of printing procedures for the electronic translator in accordance with the present invention. The printing procedures are as follow:

Step 30: selecting an information item of a corresponding translation data of a vocabulary word. An inquiry data such as a vocabulary word has a corresponding translation data which comprises several different kinds of information items, such as pronunciation, meaning, tenses, related phrases, antonyms, and example sentences. The user can select different information items to be printed out.

Step 32: searching a vocabulary word according to the inquiry data. After the information item of corresponding translation data is selected, the user can perform a search upon an inquiry data to obtain its corresponding translation data.

Step 34: determining whether the inquiry data will be printed; the user can decide whether it is necessary to print out the corresponding translation data of the inquiry data; if the user wants to perform a printing process, step 36 is performed; otherwise, step 32 is performed.

Step 36: marking the inquiry data. The CPU 10 marks the inquiry data and records the corresponding translation data in the memory 14. The data is preferably printed using a batch printing method, which can reduce the quantity of printing papers used.

Step 38: determining whether another inquiry data is to be performed; if so, step 32 is performed; otherwise, step 40 is performed.

Step 40: determining whether the inquiry data is to be printed out; if so, step 42 is performed; if not, step 32 is performed.

Step 42: printing out the selected information item of the marked inquiry data. The CPU 10 outputs the selected inquiry data or data printing and the selected information item thereof to the printer driver 20, then the printer driver 20 drives the printer 22 to print the selected information item of the marked inquiry data or data out.

In the present invention, the electronic translator uses a batch printing method to print out the selected information item of the marked inquiry data or data out; however, the electronic translator can also print out one selected information item of the marked inquiry data or data each time, which means that after step 34, step 42 is performed to print the selected information item of the marked inquiry data out according to step 30.

According to the above description, the electronic translator of the present invention has the following improvements:

(1) It can print out the translation data: the user can set up printing columns and mark an inquired vocabulary word; the electronic translator will then print out the corresponding translation data of the marked vocabulary word according to the printing columns.

(2) It can reduce the amount of print paper used: since the electronic translator uses a batch printing method, all related translation data can be arranged on one piece of paper so that the amount of printing paper used is reduced.

Although the present invention has been explained in relation to its preferred embodiment, it is to be understood that many other possible modifications and variations can be made without departing from the spirit and scope of the invention as hereinafter claimed.

1. An electronic translator with a printing functionality comprising:
a memory, for storing a plurality of vocabulary words and corresponding translation data thereof;
an input device, for outputting an instruction, wherein the instruction is corresponding to one of the vocabulary words;
a central processing unit, for searching and outputting the vocabulary words and the corresponding translation data thereof according to the instruction;
a display device, for displaying the vocabulary words and the corresponding translation data thereof;
a printer; and
a printer driver, for driving the printer to print out the vocabulary words and the corresponding translation data thereof.

2. The electronic translator as claimed in claim 1, wherein the printer prints the vocabulary words and the corresponding translation data thereof utilizing a batch print method.

3. The electronic translator as claimed in claim 1, wherein the printer prints the vocabulary words and the corresponding translation data thereof one by one.

4. The electronic translator as claimed in claim 2, wherein the instruction further is used to set a print column format so that the printer can print out the print out the vocabulary words and the corresponding translation data thereof according to the column format.

5. The electronic translator as claimed in claim 3, wherein the instruction further is used to set a print column format so that the printer can print out the print out the vocabulary words and the corresponding translation data thereof according to the column format.

6. The electronic translator as claimed in claim 1 further comprising an audio device for generating related audio for the searched data.

7. A method of providing printing functionality in an electronic translator comprising:
(A) selecting an information item of a corresponding translation data of a vocabulary word;
(B) searching the vocabulary word according to the inquiry data;
(C) determining whether the inquiry data will be printed; if so, performing step (D); if not, performing step (B);
(D) marking the inquiry data;
(A) determining whether another inquiry data is to be performed; if so, performing step (F); if not, performing step (B);
(E) determining whether the inquiry data is to be printed out; if so, performing step (G); if not, performing step (B); and
(F) printing out the selected information item of the marked inquiry data.

8. The method as claimed in claim 7, wherein the at least one printing item comprises a pronunciation, a meaning, a tense, a phrase, an antonym, or an example sentence for the vocabulary word.
